(19) United States
(12) Patent Application Publication
(10) Pub. No.: US 2025/0333038 A1
(43) Pub. Date: Oct. 30, 2025

(54) ELECTROMECHANICAL BRAKE ACTUATOR

(71) Applicant: ZF Active Safety US Inc., Livonia, MI (US)

(72) Inventors: Galus Chelaidite, South Lyon, MI (US); Kraig E. Gerber, Plymouth Township, MI (US)

(21) Appl. No.: 18/646,229

(22) Filed: Apr. 25, 2024

(51) Int. Cl. B60T 13/74; F16D 55/226; F16D 65/18; F16D 121/24; F16D 125/40

(52) U.S. Cl. CPC B60T 13/746; F16D 55/226; F16D 65/18; F16D 2121/24; F16D 2125/40

(57) ABSTRACT

An electromechanical brake actuator for applying braking force to a rotor includes a first ball nut assembly having a first spindle and a first nut axially movable relative to the rotor in response to rotation of the first spindle. A second ball nut assembly includes a second spindle and a second nut axially movable relative to the rotor in response to rotation of the second spindle. A motor supplies torque to the spindles such that both spindles rotate to cause both nuts to simultaneously move towards the rotor for applying braking force thereto. An anti-rotation member is secured to both the first and second nuts for limiting relative movement between the first and second nuts.

### TECHNICAL FIELD

The present invention relates to braking systems and, in particular, relates to an electromechanical brake having twin pistons connected to one another.

### BACKGROUND

Current vehicles are equipped with electric motor service brakes for helping control vehicle braking depending on any scenario. The service brakes rely on one or more movable pistons that selectively apply force to brake pads in order to slow down or stop rotating wheel rotors on the vehicle. The electric motor direction of rotation can be reversed to release or reduce braking in emergency dynamic scenarios or drive-away scenario from standstill condition.

### SUMMARY

In one example, an electromechanical brake actuator for applying braking force to a rotor includes a first ball nut assembly having a first spindle and a first nut axially movable relative to the rotor in response to rotation of the first spindle. A second ball nut assembly includes a second spindle and a second nut axially movable relative to the rotor in response to rotation of the second spindle. A motor supplies torque to the spindles such that both spindles rotate to cause both nuts to simultaneously move towards the rotor for applying braking force thereto. An anti-rotation member is secured to both the first and second nuts to support the back-drive torque in each first and second nut, thereby preventing rotation of the first and second nuts with respect to the first and second spindles respectively. The anti-rotation member therefore limits relative movement between the first and second nuts to help synchronize movement of the nuts during braking operations.

In another example, an electromechanical brake actuator for applying braking force to a rotor includes a first ball nut assembly having a first spindle and a first nut axially movable relative to the rotor in response to rotation of the first spindle. A second ball nut assembly includes a second spindle and a second nut axially movable relative to the rotor in response to rotation of the second spindle. A gear train is connected to the first and second spindles. A single motor supplies torque to one of the spindles and therefore to the gear train such that both spindles rotate to thereby cause both nuts to simultaneously move towards the rotor for applying braking force thereto. An anti-rotation member is secured to both the first and second nuts for limiting relative movement between the first and second nuts.

In another example, a method of providing an anti-rotation member on first and second ball nut assemblies of an electromechanical brake actuator includes arranging ends of nuts of the ball nut assemblies in a co-planar manner. The anti-rotation member is heated to expand first and second openings therein. The nuts of the first and second ball nut assemblies, which may be cooled themselves, are passed into the first and second openings. The anti-rotation member is allowed to cool to the ambient temperature which will cause it to contract the first and second openings and secure the anti-rotation member to the first and second ball nut assemblies, which are allowed to heat to the ambient temperature, to thereby limit relative movement therebetween.

Other objects and advantages and a fuller understanding of the invention will be had from the following detailed description and the accompanying drawings.

### BRIEF DESCRIPTION OF THE DRAWINGS

FIG. 1 is a schematic illustration of a vehicle having a braking system.

FIG. 2 is a perspective view of a portion of an example caliper assembly for the braking system of FIG. 1.

FIG. 3 is a section view of the caliper assembly taken along line 3-3 in FIG. 2.

FIG. 4 is a schematic illustration of an anti-rotation member of the caliper assembly.

FIG. 5A is a side view of a first step of securing the anti-rotation member to a pair of nuts.

FIG. 5B is a side view of a second step of securing the anti-rotation member to the pair of nuts.

FIG. 6A is a side view of FIG. 3 during a braking operation.

FIG. 6B is a bottom view of a portion of the caliper assembly taken in the direction 6B-6B in FIG. 3.

### DETAILED DESCRIPTION

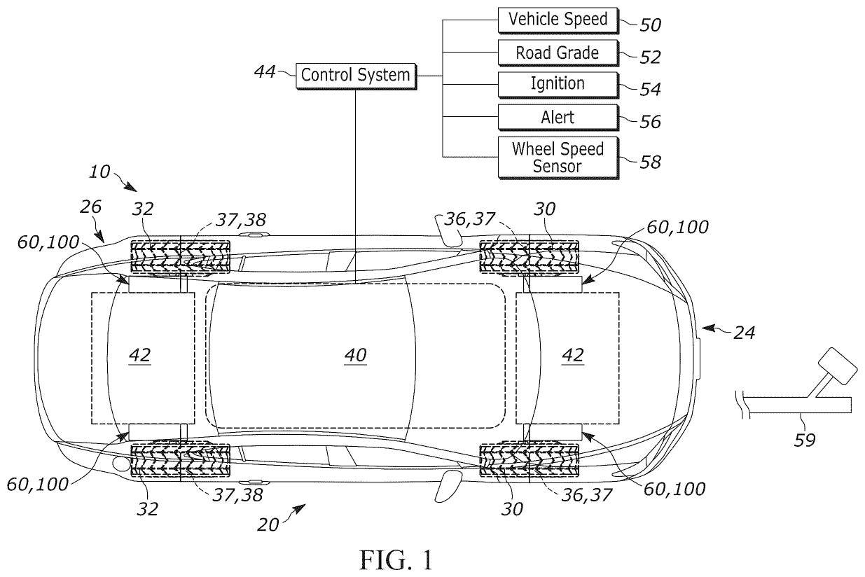

The present invention relates to braking systems and, in particular, relates to an electromechanical brake having twin pistons connected to one another. FIG. 1 illustrates an example electric brake/braking system 10 for a motor vehicle 20 in accordance with the present invention. The vehicle 20 can be an electric, hybrid or internal combustion engine powered vehicle.

The vehicle 20 extends from a first or front end 24 to a second or rear end 26. A pair of steerable wheels 30 is provided at the front end 24. Each wheel 30 includes a wheel rotor 36 driven and steered by a steering linkage (not shown). A pair of steerable or non-steerable wheels 32 is provided at the rear end 26. Each wheel 32 includes a wheel rotor 38 driven by a steering linkage (not shown). Friction brake pads 37 are associated with each wheel rotor 36, 38 and positioned on opposite sides thereof.

In the case of an electric vehicle, a battery 40 supplies power to the vehicle 20 and cooperates with front and/or rear powertrains 42 to supply torque to the wheels 30. In other words, the battery 40 forms part of the vehicle propulsion system.

A caliper or caliper assembly 60 is provided on at least one of the wheel rotors 36, 38 and controls both service braking and the parking brake associated with that wheel rotor. As shown, each wheel rotor 36, 38 on the front and rear ends 24, 26 includes a caliper assembly 60. The caliper assembly 60 is an electromechanical brake and therefore does not rely on or require hydraulic fluid to operate.

A control system 44 is provided to help control operation of the vehicle 20, such as operation of the propulsion system and vehicle braking, including operation of the caliper assemblies 60. To this end, the control system 44 can include one or more controllers, such as a propulsion system controller, motor controller, and/or brake controller. That said, the control system 44 is connected to and receives signals from various sensors that monitor vehicle functions and environmental conditions.

For example, a vehicle speed/acceleration sensor 50 monitors the vehicle speed and acceleration and generates signals indicative thereof. A road grade sensor 52 can detect or calculate the slope of the road on which the vehicle 20 is driving and generate signals indicative thereof. An ignition sensor 54 generates signals indicative of ignition status. A wheel speed sensor 58 is provided on/adjacent to each wheel 32 and generates signals indicative of the speed at each wheel. The control system 44 also receives signals indicative of the degree-including velocity and acceleration-a brake pedal 59 is depressed.

The control system 44 can receive and interpret these signals and perform vehicle functions, e.g., braking, in response thereto. In one example, the control system 44 can detect wheel slip between one or more wheels 30, 32 and the driving surface based on the sensors 50, 58 and perform anti-lock braking (ABS) and/or electronic stability control (ESC) using one or more caliper assemblies 60. The control system 44 can also be connected to an alert 56 for notifying the driver/operator of the vehicle 20 of vehicle conditions, vehicle status, braking operations, and/or environmental conditions.

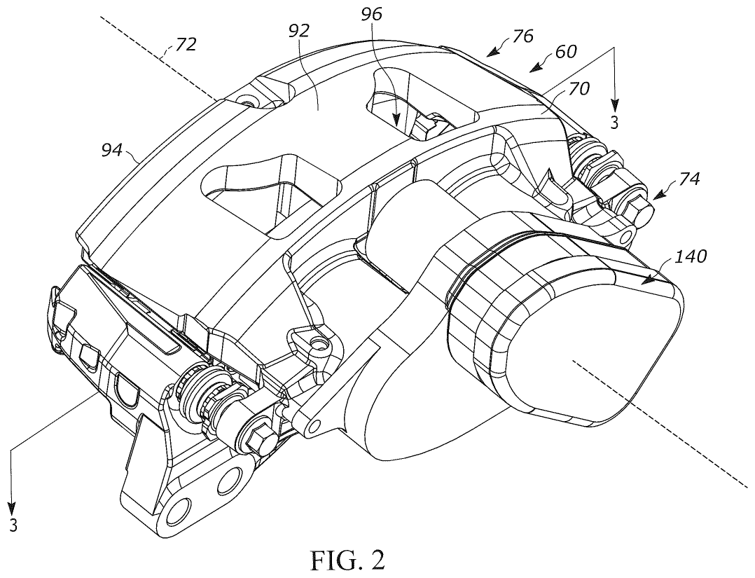

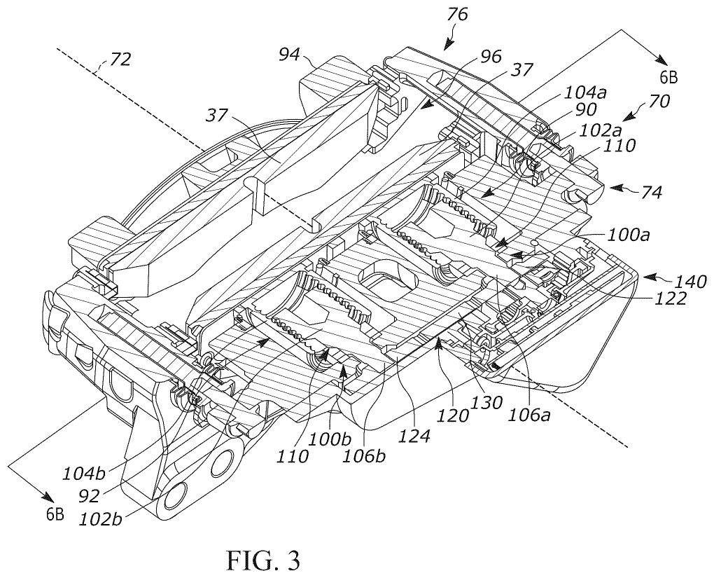

Referring to FIGS. 2 and 3, the caliper assembly 60 includes a housing 70 extending along a centerline 72 from a first end 74 to a second end 76. A bridge 80 extends from the second end 74 of the housing 70 and along/parallel to the centerline 72. A projection 82 extends from the bridge 80 and transverse to the centerline 72. The bridge 80 and projection 82 cooperate to define a channel 88 for receiving the rotor 36 or 38 of one of the wheels 30 or 32 and the brake pads 37 associated therewith.

First and second bores or passages 90, 92 extend into the housing 70 and parallel to the centerline 72. First and second ball nut assemblies (BNA) 100a, 110b are provided in the passages 90, 92 for selectively applying braking force F to the rotor 36 or 38 via the brake pads 37 in a known and controllable manner. Each BNA 100a, 100b includes a spindle 102a and an associated ball nut 104a, 104b operably coupled thereto. Recirculating balls are provided between the spindles 102a, 102b and respective ball nuts 104a, 104b for facilitating the relative axial movements. Ends 106a, 106b of the respective spindles 102a, 102b extend out of the passages 90, 92. Each ball nut 104a, 140b has an end face 108a, 108b facing the brake pads 37.

The caliper assembly 60 can be configured as a ball nut assembly (recirculating or non-recirculating), a roller screw, a ball ramp assembly or any high efficiency mechanical assembly capable of converting rotary motion of the spindle to linear motion of the piston(s). Examples of ball nut and ball ramp assemblies can be found in U.S. Pat. No. 9,976,614 and U.S. Patent Publication No. 2019/0331180, the entirety of which are incorporated herein by reference.

In this example, the ball nuts 104a, 104b are coupled to the spindles 102a, 102b such that rotation of the spindles results in axial movement of the ball nuts, as long as the ball nuts are prevented from rotating themselves. In this manner, the ball nuts 104a, 104b act as pistons for applying the braking force F during braking operations. A thrust bearing 110 is provided on each spindle 102a, 102b and within each passage 90, 92 for preventing axial movement of the spindles, and supporting the braking force F generated during braking operations.

A gear train 120 is coupled to both spindles 102a, 102b. In one example, the gear train 120 includes a first gear 122 rotatable with the spindle 102a and a second gear 124 rotatable with the spindle 102b. The first and second gears 122, 124 can be fixed to, e.g., have a splined connection with, the ends 106a, 106b of the respective spindles 102a, 102b to prevent relative rotation therebetween. An idler gear 130 is provided between and meshed with both the first and second gears 122, 124. Consequently, torque supplied to the splined end 106a via the first gear 122 is transferred, via the idler gear 130, to the second gear 124 and thus to the splined end 106b. Furthermore, the idler gear 130 helps to ensure the gears 122, 124 rotate in the same direction and, thus, the spindles 102a, 102b rotate in the same direction.

A single motor or actuator 140 is provided for simultaneously supplying torque to both BNAs 100a, 100b. To this end, the motor 140 includes a pinion gear 142 connected to the end 106a of the spindle 102a and rotatable therewith via splined connection or the like. Alternatively, the pinion gear 142 can be fixed for rotation with the end 106b of the spindle 102b (not shown). In another example (not shown), the pinion gear 142 can be fixed for rotation with the idler gear 130. In other words, the motor 140 can supply torque directly to the spindle 102a, (and therefore indirectly to the spindle 102b), directly to the spindle 102b (and therefore directly to the spindle 102a) or directly to the idler gear 130 (and therefore indirectly to both spindles 102a, 102b). Regardless, the single motor 140 cooperates with the gear train 120 to simultaneously supply torque to both BNAs 100a, 100b.

As noted, the first and second BNAs 100a, 100b are provided in the respective passages 90, 92. Typically, the pistons of BNAs include structure for preventing rotation of the piston within its housing passage and relative to the spindle, e.g., friction ring, cooperating projection and recess, etc. This structure, however, is absent in this EMB actuator 10 of the present invention. Instead, the EMB actuator 10 utilizes a piston-to-piston anti-rotation member 150 for limiting or preventing relative movement, e.g., rotational, pivoting, and/or axial, between the pistons during braking events.

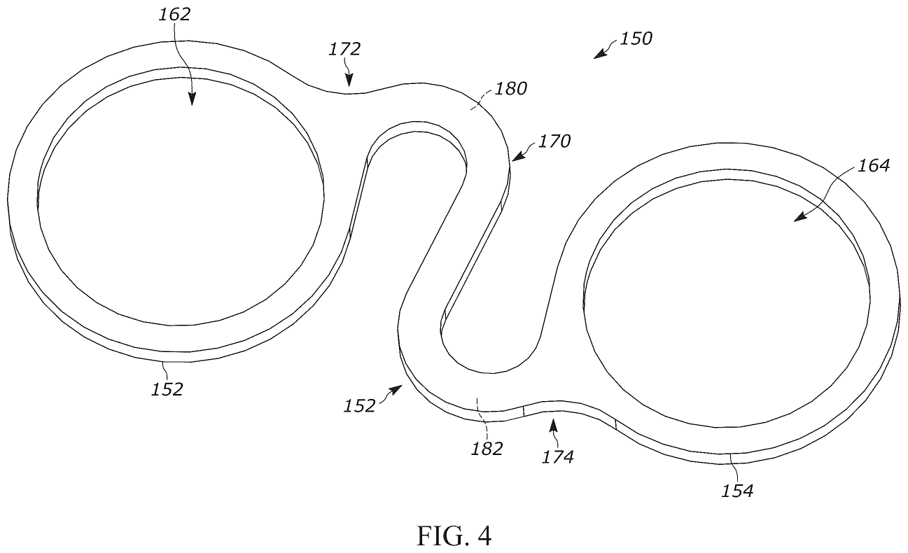

In one example shown in FIG. 4, the anti-rotation member constitutes a plate 150 having a first portion 152 and a second portion 154. The first portion 152 includes an opening 162 for receiving the first piston 110a. The second portion 154 includes an opening 164 for receiving the second piston 110b. A resilient band 170 interconnects the first and second portions 152, 154. To this end, the band 170 extends from a first end 172 integrally formed with or rigidly fixed to the first portion 152 to a second end 174 integrally formed with or rigidly fixed to the second portion 154. The band 170 is configured, e.g., sized and shaped, to allow for a predefined degree of movement between the first and second portions 152, 154.

Optionally, the band 170 can be hinged to the portions 152, 154 at respective locations indicated in phantom at 180, 182 to allow for a prescribed degree of movement between the portions and, thus, allow for a prescribed degree of relative movement between the nuts 104a, 104b. In any case, the band 170 is made of a resilient material, such as a metal, plastic or polymer.

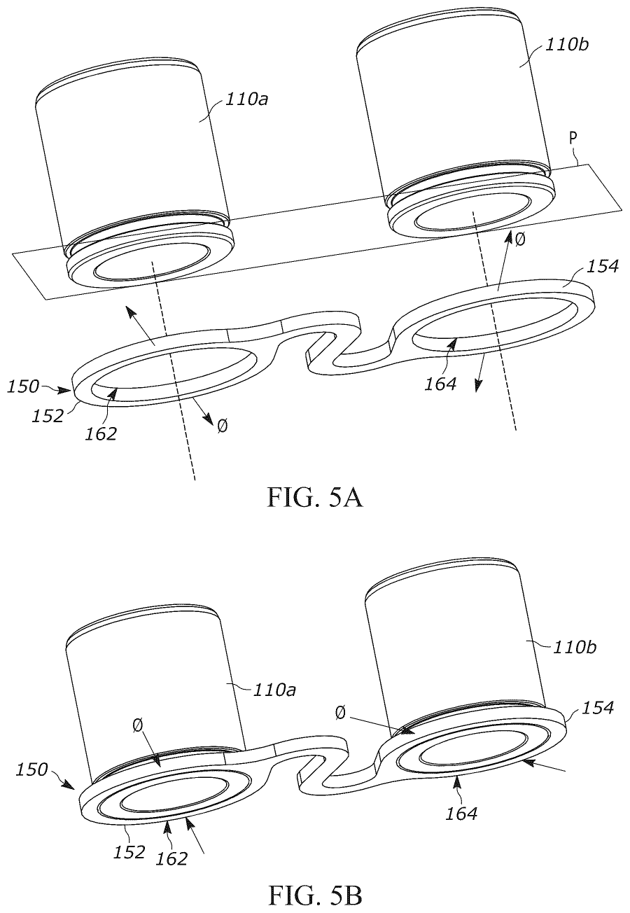

The anti-rotation member 150 can be installed on the pistons 110a, 110b in the manner illustrated in FIGS. 5A-5B. First, the pistons 110a, 110b are checked to ensure that they are parallel to one another and the end faces positioned in the same plane P. Next, the anti-rotation member 150 is heated sufficient to expand the openings 162, 164 in the first and second portions 152, 154. Expansion of the diameters of the openings 162, 164 is indicated generally by the outwardly extending arrows @ in FIG. 5A. At this point, the anti-rotation member 150 is slipped or press fit over each of the pistons 110a, 110b until the bottom surface of the plate and the piston end faces 108a, 108b extend within the same plane P in FIG. 5B. Alternatively, the anti-rotation member 150 may reside outside the plane P but the end faces 108a, 108b are always co-planar with one another.

The anti-rotation member 150 is then cooled (passively or actively) until it has the same temperature as the pistons 110a, 110b. With this in mind, the materials for the anti-rotation member 150 and the pistons 110a, 110b are chosen to be similar/the same such that their thermal expansion coefficients are likewise comparable/equal. That said, this cooling causes the openings 162, 164 to shrink and thereby cause the portions 152, 154 to contract into engagement with the respective pistons 104a, 104b. Contraction of the diameters of the openings 162, 164 is indicated generally by the inwardly extending arrows @ in FIG. 5B. The contraction creates robust interference fits between the anti-rotation member 150 and each piston 104a, 104b. That said, the first and second portions 152, 154 are not movable relative to the respective pistons 104a, 104b during normal operation of the EMB actuator 10.

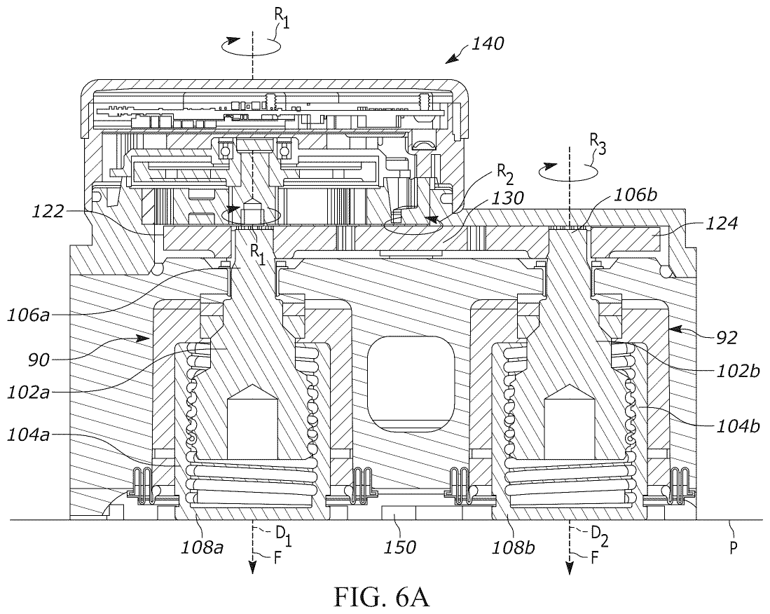

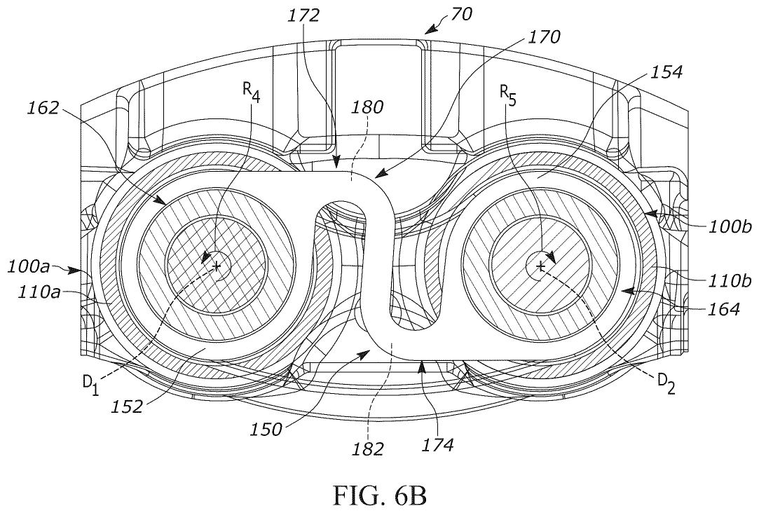

Referring to FIGS. 6A-6B, during operation of the braking system 10, a service brake demand initiated by the system and/or vehicle operator causes the control system 44 to actuate the motor 140 associated with at least one caliper assembly 60. In this example, service braking is shown for a single, rear end 26 wheel rotor 38.

In particular, the control system 44 actuator the motor 140 to rotate the pinion gear 142 in a first direction (indicated as clockwise at R₁ in FIG. 6A). Rotation of the pinion gear 142 in the manner R₁ likewise causes the first gear 122 coupled thereto to rotate in the manner R₁. At the same time, the spindle 102a coupled to the first gear 122 also rotates in the manner R₁. Torque from the first gear is transferred to the idler gear (which rotates in the counterclockwise manner R₂), which is then transferred to the second gear 124 (which rotates in the clockwise manner R₃). Rotation of the second gear 124 in the manner R₃ likewise causes the spindle 102b to rotate in the manner R₃. That said, the spindles 102a, 102b rotate in the same directions R₁, R₃ at the same time. It will be appreciated that the manners R₁, R₃ could likewise be counterclockwise as viewed in FIG. 6A and that the manner R₂ could therefore be clockwise as viewed in FIG. 6A (not shown).

As noted, the motor 140 could be alternatively directly connected to the spindle 102b or the idler gear 130. In those scenarios, the motor 140 will directly rotate the spindle 102b in the direction R₃ or directly rotate the idler gear 130 in the direction R₂ (not shown). In any case, simultaneous rotation of the spindles 102a, 102b in the directions R₂, R₃ causes the ball nuts 104a, 104b to longitudinally advance towards the brake pads 37 and cause the brake pads to apply braking force F to the rotor 36.

As the ball nuts 104a, 104b move along the axes D₁, D₂ towards [or away from] the brake pads 37, the anti-rotation member 150 helps maintain the ball nuts 104a, 104b in fixed or substantially fixed positions relative to one another. In other words, the anti-rotation member 150 helps to limit or prevent relative rotational movement between the nuts 104a, 104b. To this end, the interference fits between the portions 152, 154 of the anti-rotation member 150 and the respective nuts 104a, 140b helps provide a secure connection between the member 150 and the nuts that is maintained during the apply and release of the braking force F. Consequently, synchronization of the BNA 100a, 100b movement can be maintained during the lifetime of the caliper assembly 60.

More specifically, the anti-rotation member 150 can limit or prevent either of the nuts 104a, 104b from rotating about its axis D₁, D₂. This alleviates the need to provide cooperating, anti-rotation structure on the nuts 104a, 104b and interior wall of the housing 70 defining the passages 90, 92. At the same time, the anti-rotation member 150 can help limit or prevent axial movement between the nuts 104a, 140b. This helps to synchronize the BNAs 100a, 100b such that the braking forces F are applied to the rotor 36 at the same or substantially the same time.

The anti-rotation member 150 can also help limit or prevent tilting/pivoting of the nuts 104a, 104b relative to the axes D₁, D₂ to accommodate loads that may tend to deflect the BNAs 100a, 100b out of parallelism during dynamic events. It will be appreciated, however, that the resilient band 170 connecting the portions of the anti-rotation member 150 can be configured to allow some prescribed movement of one or both nuts 104a, 104b to account for tangential taper on the brake pad 37, especially when new and manufactured with a small amount of tangential taper. With this in mind, and returning to FIG. 4, providing the resilient band 170 with the optional hinges 180, 182 can help compensate for tapering of the brake pad 37 over time. More specifically, hinging the resilient band 170 can help increase flexibility in the anti-rotation member 150 to accommodate some relative rotation between the nuts 104a, 104b.

In one example shown in FIG. 6B, the brake pad 37 is tangentially tapered such that the nut 104a is slightly rotated in the manner R₄ about the axis D₁ (counterclockwise as shown) which, in turn, causes the other nut 104b to rotate slightly in the opposite direction in the manner R₅ (clockwise about the axis D₂) due to the anti-rotation member 150 being secured to both nuts. Reverse rotation of the nuts 104a, 104b means that one of nuts moves closer to the brake pad 37 (extends) while the other nut moves further away from the brake pad (retracts). In this scenario, the hinges 180, 182 in the resilient band 170 accommodate the reverse rotations while keeping the nuts 104a, 104b parallel to one another and to contact the brake pad 37 with the same force.

The actuator 10 can include structure for applying the parking brake to the rotor 36. This can include, for example, a clutch, a bistable locking mechanism, etc. One example parking brake is shown and described in U.S. patent application Ser. No. 17/374,423, filed Jul. 13, 2021, the entirety of which is incorporated herein by reference. When the parking brake is no longer needed, e.g., drive-away release (DAR) or parking release event, the control system 44 rotates the motor 140 in a direction opposite to R₁ to simultaneously reverse rotate both spindles 102a, 102b. This cause the pistons 104a, 104b to move axially along and relative to the spindles 102a, 102b back to their initial condition under the influence of the relaxing bridge 92 of the housing 70.

The present invention is advantageous in that using two simultaneously acting pistons to apply the braking force instead of one helps to minimize or eliminate tangential wear on the brake pad while improving BNA durability due to the reduced articulation requirement. With this in mind, providing an anti-rotation member on the BNA pistons to limit or prevent relative movement therebetween obviates the need for cooperating structure on each nut and caliper body passage while allowing the BNA piston movement to be synchronized for each braking operation.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An electromechanical brake actuator for applying braking force to a rotor, comprising:
a first ball nut assembly including a first spindle and a first nut axially movable relative to the rotor in response to rotation of the first spindle;
a second ball nut assembly including a second spindle and a second nut axially movable relative to the rotor in response to rotation of the second spindle;
a motor for supplying torque to the spindles such that both spindles rotate to cause both nuts to simultaneously move towards the rotor for applying braking force thereto; and
an anti-rotation member secured to both the first and second nuts for limiting relative rotational movement between the first and second nuts.

2. The brake actuator recited in claim 1, further comprising a gear train connected to the first and second spindles.

3. The brake actuator recited in claim 2, wherein the gear train comprises a first gear rotatable with the first spindle, a second gear rotatable with the second spindle, and an idler gear meshed with the first and second gears.

4. The brake actuator recited in claim 3, wherein the motor supplies torque directly to the idler gear.

5. The brake actuator recited in claim 1, wherein the motor supplies torque directly to first spindle and indirectly to the second spindle.

6. The brake actuator recited in claim 1, wherein the anti-rotation member extends from the first nut to the second nut and moves with the nuts.

7. The brake actuator recited in claim 1, wherein the anti-rotation member comprises a plate having a first portion with a first opening for receiving the first nut and a second portion with a second opening for receiving the second nut.

8. The brake actuator recited in claim 7, further comprising a resilient band connecting the first and second portions for allowing a predetermined degree of deflection of at least one of the nuts relative to a centerline thereof.

9. The brake actuator recited in claim 8, wherein the resilient band has a hinged connection with each of the first and second portions for allowing a prescribed degree of relative rotation between the first and second nuts to account for wear on brake pads of the actuator.

10. The brake actuator recited in claim 7, wherein the anti-rotation member maintains the first and second nuts parallel to one another during brake force application.

11. The brake actuator recited in claim 7, wherein the first portion has an interference fit with the first nut and the second portion has an interference fit with the second nut.

12. The brake actuator recited in claim 1, wherein the anti-rotation member further limits at least one of relative axial movement and relative pivoting between the first and second nuts.

13. An electromechanical brake actuator for applying braking force to a rotor, comprising:
a first ball nut assembly including a first spindle and a first nut axially movable relative to the rotor in response to rotation of the first spindle;
a second ball nut assembly including a second spindle and a second nut axially movable relative to the rotor in response to rotation of the second spindle;
a gear train connected to the first and second spindles;
a single motor for supplying torque to one of the spindles and therefore to the gear train such that both spindles rotate to thereby cause both nuts to simultaneously move towards the rotor for applying braking force thereto; and
an anti-rotation member secured to both the first and second nuts for limiting relative rotational movement between the first and second nuts.

14. The brake actuator recited in claim 13, wherein the gear train comprises a first gear rotatable with the first spindle, a second gear rotatable with the second spindle, and the idler gear meshed with the first and second gears.

15. The brake actuator recited in claim 13, wherein the anti-rotation member comprises a plate having a first portion with a first opening for receiving the first nut and a second portion with a second opening for receiving the second nut.

16. The brake actuator recited in claim 15, further comprising a resilient band connecting the first and second portions for allowing a predetermined degree of deflection of at least one of the nuts relative to a centerline thereof.

17. The brake actuator recited in claim 16, wherein the resilient band has a hinged connection with each of the first and second portions for allowing a prescribed degree of relative rotation between the first and second nuts to account for wear on brake pads of the actuator.

18. The brake actuator recited in claim 15, wherein the anti-rotation member maintains the first and second nuts parallel to one another during a braking operation.

19. A method of providing an anti-rotation member on first and second ball nut assemblies of an electromechanical brake actuator, comprising:
arranging ends of nuts of the ball nut assemblies in a co-planar manner;
heating the anti-rotation member to expand first and second openings therein;
passing the nuts of the first and second ball nut assemblies into the first and second openings; and
cooling the anti-rotation member to shrink the first and second openings and secure the anti-rotation member to the first and second ball nut assemblies to thereby limit relative movement therebetween.

20. The method recited in claim 19, wherein the anti-rotation member comprises:
a first portion with the first opening for receiving the nut of the first ball nut assembly;
a second portion with the second opening for receiving the nut of the second ball nut assembly;
a resilient band connecting the first and second portions for allowing a predetermined degree of relative movement between the nuts during a braking operation.

21. The method recited in claim 20, wherein the first and second portions have interference fits with the nuts of the respective first and second ball nut assemblies.

22. The method recited in claim 19, wherein the anti-rotation member further limits at least one of relative axial movement and relative pivoting between the nuts of the first and second ball nut assemblies.
